(19) United States
(12) Patent Application Publication
(10) Pub. No.: US 2003/0037174 A1
(43) Pub. Date: Feb. 20, 2003

(54) Common adapter/connector architecture

(76) Inventors: David Lavin, Dallas, TX (US); Daniel G. Jones, Centreville, VA (US); Todd Lee Landrum, Frisco, TX (US)

Correspondence Address: STAAS & HALSEY LLP, 700 11TH STREET, NW, SUITE 500, WASHINGTON, DC, 20001, US

(21) Appl. No.: 09/734,714

(22) Filed: Dec. 13, 2000

Related U.S. Application Data
(60) Provisional application No. 60/236,711, filed on Oct. 2, 2000.

(51) Int. Cl. G06F 9/00; G06F 9/44; G06F 9/46

(52) U.S. Cl. 709/313; 709/328

(57) ABSTRACT

In a method, apparatus, and computer-readable medium, interfacing between middleware software and application software uses a plug and socket approach in which application-specific services and resources are isolated into the plug and middleware-specific components are isolated into the socket. The plug and the socket communicate with each other through an interface. The socket communicates with middleware software through an application program interface, and the plug communicates with application software through an application program interface. Therefore, the plug is isolated from communicating with the middleware software, and the socket is isolated from communicating with the application software.

### CROSS REFERENCE TO RELATED APPLICATION

This application is related to provisional U.S. application entitled COMMON ADAPTER/CONNECTOR ARCHITECTURE having Ser. No. 60/236711, and having Attorney Docket No. 1330.1094P, filed Oct. 2, 2000, incorporated by reference herein, and priority to which is claimed.

### BACKGROUND OF THE INVENTION

1. Field of the Invention

The present invention is directed to middleware software, and more particularly, to message brokers and to adapters/connectors within enterprise integration, and, further, to software development kits.

2. Description of the Related Art

A brief overview of Enterprise Application Integration (EAI), middleware software, message brokers, adapters/connectors, and software development kits (SDK) is presented.

Middleware and EAI

In recent years, EAI has emerged as a popular method for helping businesses overcome the challenge of integrating various systems and components within their enterprise. As more emphasis is given to integrating applications both within the enterprise and across multiple enterprises, middleware software, which provides the technological backbone for EAI, has become an important tool for many businesses.

The role of middleware software is to manage the complexities of integrating multiple systems across varied operating systems, networks, and hardware. Currently, there are a multitude of middleware products available, ranging from simple RPC-based solutions to message-oriented middleware to products with sophisticated tool sets allowing development of canonical data models that exist across the enterprise.

As middleware technology advances, application integration moves towards a more plug-and-play solution set where multiple applications are coordinated into a single “virtual system”, creating an integrated information technology (IT) infrastructure that can exchange information across technical and organizational boundaries.

Message Brokers and Adapters/Connectors

An example of Enterprise Application Integration is the integration of several application software programs using middleware software, enabling a user to access all of the integrated application programs. FIG. 1 shows a computer system 100 in which a user accesses a computer 102 using a device 104, such as a personal computer, coupled to the computer 102 either directly or through a network 106, such as the Internet or a Virtual Private Network (VPN). More particularly, the user accesses various application software programs, such as application A 108, application B 110, application C 112, application D 114, etc., being executed by the computer 102, or by various computers interconnected by the network 106. Applications A, B, C, and D are integrated with each other through middleware software corresponding to message broker 116. That is, the traditional middleware solution for EAI includes a message broker 116 used within a “hub-and-spoke” configuration of a computer system 102 as shown in FIG. 1. The message broker 116 acts as the hub of the integration, managing all communication between applications A 108, B 110, C 112, and D 114.

In order to eliminate coupling of the message broker 116 to an application 108, 110, 112, or 114, or vice versa, most middleware products use another layer of software between the message broker 116 and the application 108, 110, 112, or 114 referred to as an adapter (also known as a connector) 118 (shown in FIG. 2). This layer of software is responsible for connecting the application 108, 110, 112, or 114 to the broker 116 and converting the application interface into a form that the broker 116 expects, as shown in FIG. 2. This design principle has been previously used to translate between more granular software entities at the component and object levels, and has also been successfully applied at the enterprise software level.

By using adapters/connectors 118, applications 108, 110, 112, and 114 can be integrated with each other without altering their codebase. This is especially important for applications which are not easily modified—such as commercial off-the-shelf (COTS) applications or fragile legacy systems. An adapter/connector 118 wraps the application 108, 110, 112, or 114, creating an enterprise-level component which is easily integrated with other similar components. This allows for a higher level of interchangeability and interoperability among enterprise applications 108, 110, 112, and 114.

Adapters/connectors 118 can interact with their applications 108, 110, 112, and 114 in a variety of ways:

(1) By directly accessing the application's database(s). This allows a large amount of flexibility in how application data can be accessed, but does not allow the application's business logic to be shared within the integration. The adapters/connectors also circumvent data integrity safeguards the application may implement.

(2) By using the application's user interface. This technique, usually know as screen-scraping, is useful for interfacing with monolithic legacy systems which do not allow any other method of interaction.

(3) Through an API. This API provides controlled access to application data and business logic. These APIs can include a broad range of technologies, from basic socket APIs to more complex distributed object solutions.

This architecture is used primarily for application API interaction, although it supports other interaction types. It is also important to note that the complexity of adapters/connectors ranges widely among different middleware products. Some adapters/connectors are nothing more than simple API wrappers, mapping the interface of the application to that of the message broker. However, many middleware products add a layer of abstraction to their adapters/connectors which allows these products to provide more robust meta-data and business process functionality configured through a variety of sophisticated management tools.

Middleware products typically have numerous pre-built adapters/connectors which facilitate integrating together many different databases and applications. Adapters/connectors can also be custom coded to support specific customer requirements.

Basic Adapter/Connector Functionality

FIG. 3 shows a cross section of the functionality included in an adapter/connector 118. As shown in FIG. 3, the adapter/connector 118 provides various connection, communication, and translation functions.

The adapter/connector 118 is responsible for connection to the middleware hub 116 (usually some kind of message broker), and managing communication with the broker 116. The adapter/connector 118 also must manage connection and communication with the application 108, 110, 112, 114 being integrated into the enterprise 100.

Adapters/connectors typically perform specific startup and shutdown routines during which they manage connection states 120. Adapter/connector communication management 122 may include error logging, transaction coordination, and application data polling.

The adapter/connector must also translate 124 any messages being transmitted between the broker and the application. This translation 124 takes the data in the structure the broker 116 understands and changes the data to a structure the application 108, 110, 112, 114 understands (or vice versa). The content of the data remains constant through the translation 124 process.

Therefore, in order to provide this basic functionality, the adapter/connector must have explicit knowledge of both the message broker 116 and application 108, 110, 112, 114 API's.

Moreover, the adapter/connecter 118 manages communication 126 and connection 128 with the applications 108, 110, 112, 114.

An adapter/connector 118 can also perform data transformation—that is, the adapter/connector 118 can make changes to the data content. For example, some middleware products 116 allow for an implementation of a canonical data model across multiple applications 108, 110, 112, 114. In order to support this functionality, an adapter/connector 118 must transform the data between its data model form and its application form in addition to performing the middleware to application translation discussed herein above.

Software Development Kit (SDK)

Most middleware vendors provide a Software Development Kit (SDK) to ease development of adapters/connectors 118 for their corresponding middleware product 116. The SDK is a class library that encapsulates the complexities of connecting and communicating with the middleware product 116, completely independent of which application 108, 110, 112, 114 is being integrated, as shown in FIG. 4. That is, SDK 130 corresponds to the connection function 120 and the communication function 122 included in the adapter/connector 118.

In addition, the SDK 130 also provides the structure to which the adapter/connector 118 must conform. This structure includes defining, at an abstract level, controls for adapter/connector functionality such as startup, shutdown, error logging, transaction coordination, and application data polling. By dictating this structure through the SDK 130, the adapters/connectors 118 for the middleware product 116 can provide more sophisticated functionality configured through the visual tools (if any) provided by the vendor of the middleware product 116.

Therefore, developing the adapter/connector 118 becomes a task of adapting the translation 124 and application communication 126 functions to the interface 132 defined by the SDK 130. The developed code for the adapter/connector 118 does not need to have explicit knowledge of how to communicate with the middleware 116, only knowledge of the interface 132 presented by the SDK 130.

Thus, an adapter/connector provides basic functions, including connection, communication and translation. Moreover, an adapter/connector manages the connection with the middleware message broker and the application software, handles communication between the middleware message broker and the application software, and translates any messages so that the middleware message broker and the application software can understand each other.

The middleware SDK performs the complexities of communication with the message broker. So, with the majority of the broker-specific functionality incorporated into the SDK, the developed code becomes very application-centric. A large portion of this code retains validity regardless of which middleware tool is used.

### SUMMARY OF THE INVENTION

It is an object of the invention to organize an adapter/connector into a plug and socket and to isolate application-specific software services and resources into the plug and middleware-specific software components into the socket.

It is also an object of the invention to increase speed of adapter/connector development.

It is another object of the invention to improve software quality and consistency.

It is a further object of the invention to reduce adapter/connector development and maintenance costs.

It is an additional object of the invention to maximize code reuse across adapters/connectors.

It is yet another object of the invention to decrease the effort of adding or changing support of API services.

Moreover, it as an object of the invention to provide a framework conducive to extensive code generation.

It is yet a further object of the invention to streamline adapter/connector testing by allowing a more granular, component-based testing approach.

It is a further object of the invention to allow a division of development labor, making the most of varied subject matter experts. It is also an object of the invention to provide a common language by which basic adapter/connector functionalities can be described.

The present invention comprises a method of interfacing between middleware software and application software using a plug and socket approach. In the method of the present invention, application-specific services and resources are isolated into the plug and middleware-specific components are isolated into the socket.

The present invention also comprises an adapter/connector comprising a plug and socket in which application-specific services and resources are isolated into the plug and middleware-specific components are isolated into the socket.

Moreover, the present invention comprises a computer system implementing the above-mentioned adapter/connector plug and socket, and a computer-readable medium storing a program which when executed by a computer causes the computer to isolate application-specific services and resources into the plug of an adapter/connector and middleware-specific components into the socket of the adapter/connector.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram of a computer system of the related art.

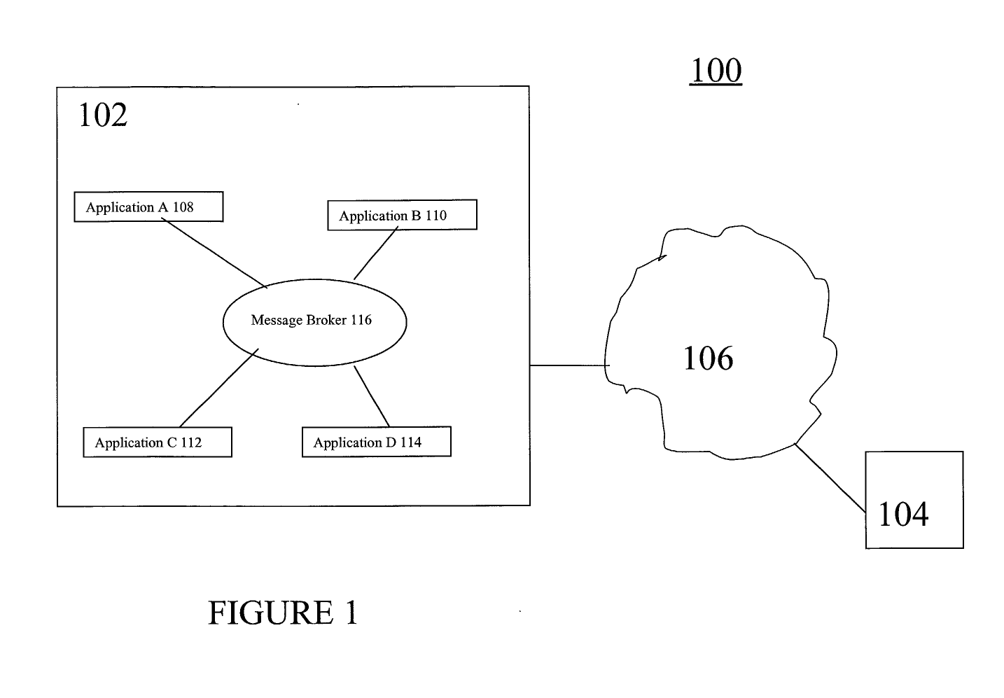

FIG. 2 is a diagram of a computer system of the related art including adapters/connectors of the related art.

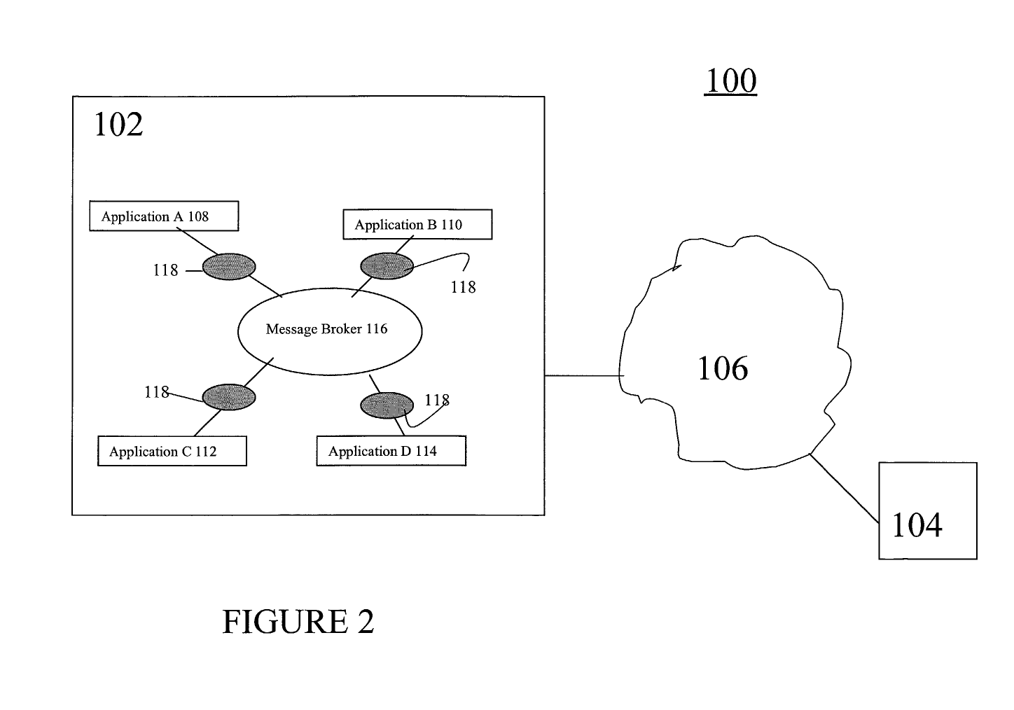

FIG. 3 is a diagram of an adapter/connector of the related art.

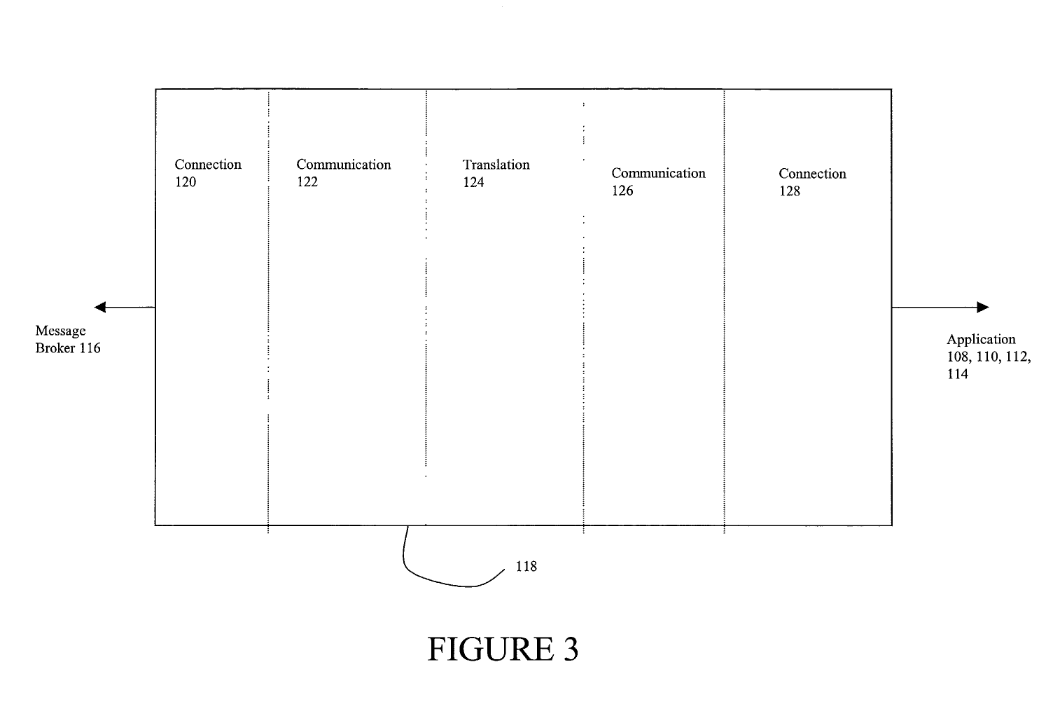

FIG. 4 is a diagram of an adapter/connector of the related art, including a software development kit.

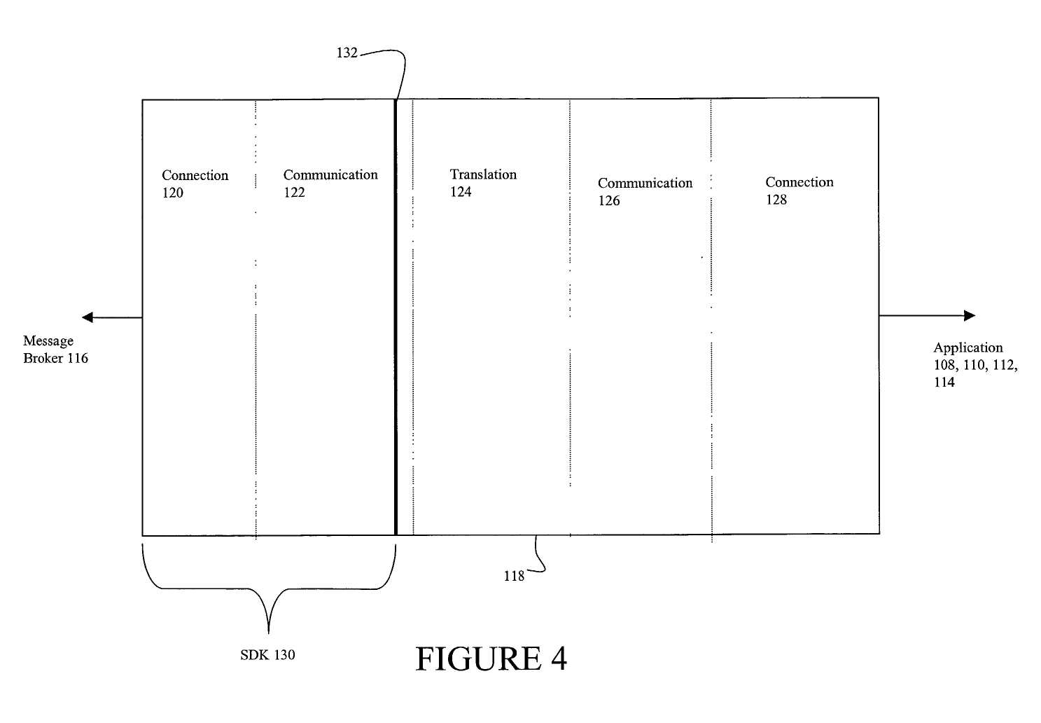

FIG. 5 is a diagram of an adapter/connector of the present invention.

FIG. 6 is an interaction diagram between objects in the present invention.

FIG. 7 is another interaction diagram between objects in the present invention.

FIG. 8 is also an interaction diagram between objects in the present invention.

FIG. 9 is a diagram of a plug 140 interface.

FIG. 10 is a diagram of IAdapterServiceManager interface.

FIG. 11 is a diagram of an IAdapterService interface and an IAdapterTranslator interface.

FIG. 12 is a diagram of an IAdapterResourceManager interface.

FIG. 13 is a diagram of an IServiceDescriptor interface.

FIG. 14 is a diagram of an ISocketServiceProvider interface.

FIG. 15 is a diagram of a ServiceParameter interface.

FIG. 16 is a diagram of a properties file.

FIG. 17 is a diagram of a computer system of the present invention.

FIG. 18 is a diagram of development processes for an adapter/connector of the present invention.

### DESCRIPTION OF THE PREFERRED EMBODIMENTS

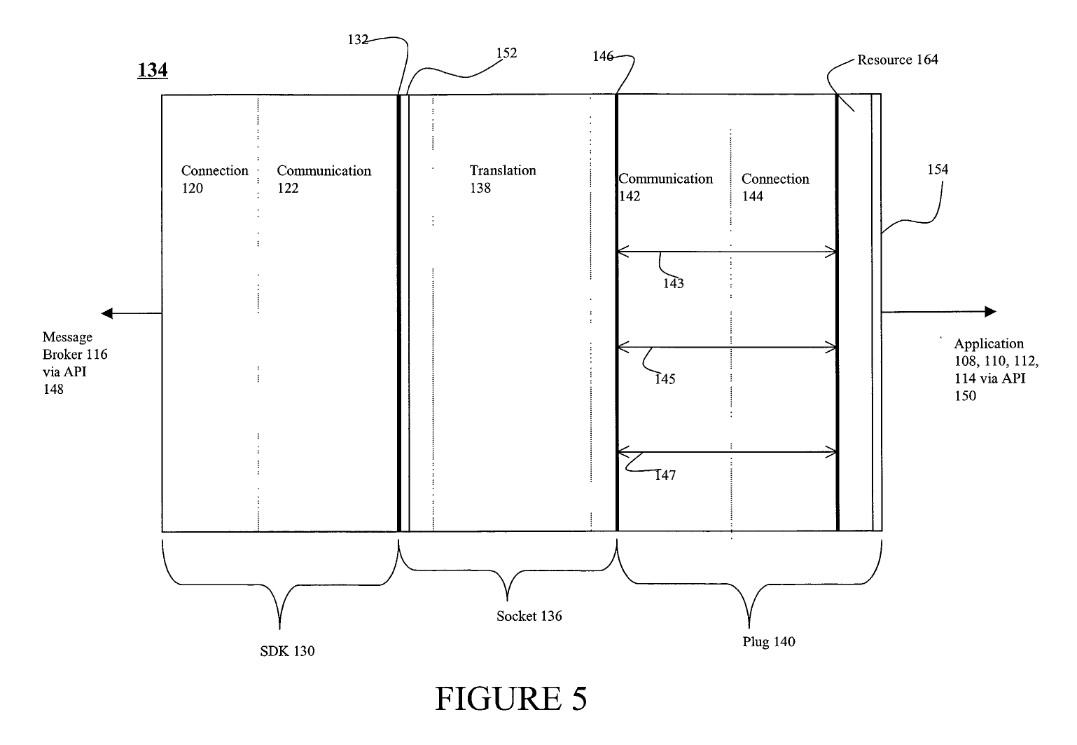

FIG. 5 is an overview of the adapter/connector 134 of the present invention. As shown in FIG. 5, the adapter/connector 134 of the present invention executes connection 120 and communication 122 functions corresponding to an SDK 130, as discussed herein above. However, in the adapter/connector 134 of the present invention, a socket 136 executes translation functions 138, and a plug 140 executes communication 142 and connection 144 functions. That is, the translation functions 138 of the adapter/connector 134 are organized into the socket 136, and the communication 142 functions and the connection functions 144 of the adapter/connector 134 are organized into the plug 140.

FIG. 5 thus shows the implementation of a method of interfacing between middleware software 116 and application software 108, 110, 112, 114 using a plug and socket approach in which application-specific services and resources are isolated into plug 140 and middleware-specific components are isolated into a socket 136.

Plug

Plug 140 of the present invention, also referred to as an application plug, provides a simplified interface for a software program, such as a message broker 116, to communicate with the application 108, 110, 112, 114. Most of the lower-level complexities of connecting and communicating with the application 108, 110, 112, 114 performed by the plug 140.

Moreover, the plug 140 of the present invention corresponds to an SDK-like class library specific to each application 108, 110, 112, 114. As a library, the plug 140 encapsulates the complexities of connecting and communicating with the application 108, 110, 112, 114, as does the SDK 130 for the middleware 116. However, since the SDK 130 imposes a certain structure onto the adapter/connector 134, the class library (or plug 140) focuses only on behavior of the plug 140 with respect to a corresponding application program interface (API). Moreover, the plug 140 is flexible so as to maintain compatibility with varied SDKs 130.

Analogous to the SDK 130 with middleware 116, the plug 140 of the present invention provides a standard interface representing the functionality of the plug 140. The plug 140 of the present invention also operates completely independently of which middleware tool 116 is being used.

Application-specific services and resources are isolated into the plug 140.

The details of the architecture of the plug 140 are disclosed in further detail herein below.

Socket

Middleware-specific adapter/connector components are isolated into a socket 136 (also referred to as a connecting socket). These middleware specific adapter/connector components are also referred to as socket components.

With the SDK 130 and the plug 140 each performing the complexities of connection and communication, the socket 136 maps the plug's 140 services (communication 142 and connection 144) into the SDK's structure 130 (including connection 120 and communication 122) and performs any data translation 138 that is needed.

The connecting socket 136 of the present invention maps the SDK's 130 interface 132 to the plug's (140) interface defined in socket/plug interface146. Translation 138 of data takes place entirely within the domain of the socket 136.

Data passing between the socket 136 and plug 140 is in a form specific to an application 108, 110, 112, or 114 (referred to as application-specific form). The socket 136 is the portion of the adapter/connector 134 that is both middleware 116 specific and application 108 specific. That is, the socket 136 is the portion of the adapter/connector 134 with explicit knowledge of both the middleware tool 116 (in the form of the SDK's interface 132) and the application 108, 110, 112, 114 (in the form of the socket/plug interface 146).

The relationship between socket 136/plug140 functionality within the adapter/connector 134 of the present invention is shown in FIG. 5.

A socket 136 is characterized as reusable or non-reusable. A reusable socket 136 is discussed in further detail herein below. A non-reusable socket 136 is one which is particular to a specific middleware 116 product. Therefore, unless a reusable socket can be created for the middleware product 116 (as discussed in further detail herein below), the socket 136 is the non-reusable portion of the adapter/connector 134.

However, as more sockets 136 are developed, lower level reusability can be gained across sockets 136 as common behavior is abstracted into inheritable classes.

Reusable Sockets

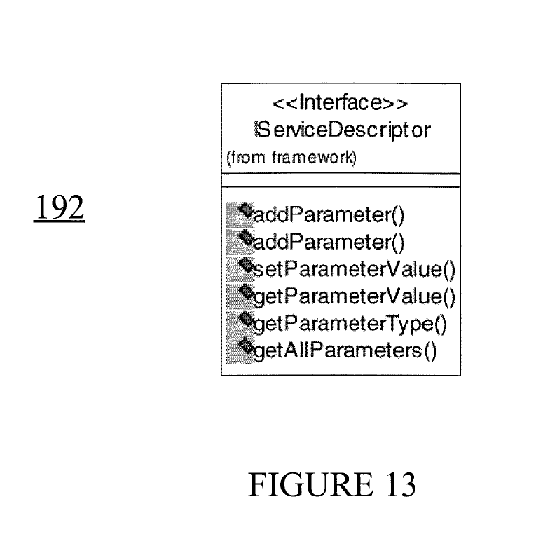

Although sockets 136 are typically the non-reusable portion of the adapter/connector 134, a reusable socket 136 adapts to whichever plug 140 the reusable socket 136 is connected to by reading the plug's 140 service descriptors to configure itself. An example of a service descriptor in the present invention is IServiceDescriptor 192 shown in FIG. 13 and discussed in further detail herein below.

Differences Between a Reusable Socket and a Non-reusable Socket

The translation function 138 (included in a translation module of the adapter/connector 134 of the present invention) would vary between a non-reusable (or plug-specific) socket and a reusable socket. In a plug-specific socket, the translation 138 translates data directly from the middleware format to the application format. A reusable socket includes a common data form to transmit information from the socket 136 to the plug 140.

For reusable sockets, the translation 138 moves the data from the middleware format to a neutral format which is then converted to the application format by the plug 140. Since this extra translation should add as little extra processing overhead as possible, this aspect of the present invention supports communication via the SAX API, which is commonly used for parsing XML. In this aspect of the present invention, the socket 136 acts as a parser, sending the data as SAX events to the listener provided by the plug 140, which allows this aspect of the present invention to take advantage of XML's platform independence without adding the extra overhead of fully converting the data to XML format.

Preferred APIs

The adapter/connector 134 of the present invention interfaces to the message broker 116 through API 148, and to the application 108 through API 150, as shown in FIG. 5. Depending upon the particular implementation of the adapter/connector 134 of the present invention and the above-mentioned APIs 148, 150, it may be desirable to include a layer of JNI™ software 152, 154 as part of the adapter/connector 134 which interfaces to the APIs 148, 150.

If, for example, the adapter/connector 134 of the present invention is developed in Java™, certain types of APIs (148, 150) for both the middleware tool (or SDK) 130 and the application 108 are more preferable. For example, on the middleware side 116, there must be support for Java™. Java's™ platform-independence makes Java™ well suited for integration of software and, some middleware tools (or SDKs)130 would require that the adapter/connector 134 be developed in Java™ to support advanced functionality.

If the middleware SDK 130 does not support Java™, the adapter/connector 134 of the present invention would include a JNI™ layer of software 152 imposed between the socket 136 as shown in FIG. 5 and the middleware SDK 130. More specifically, if the middleware SDK 130 only supports a C API, a JNI™ software layer 152 is imposed between the socket 136 and the middleware tool SDK 130, which allows Java-to-C communication to occur.

For the application API 150, a distributed object protocol is preferred. These include CORBA, RMI, DCOM, EJB, etc. Communication via XML or SOAP (Simple Object Access Protocol) is also easily supported. Native APIs such as C libraries would require the use of a JNI™ software layer 154 placed within the plug 140 of the present invention for communication with the application API 150. However, the use of a native API for the application API 150 is not as detrimental to adapter/connector 134 implementation as native APIs148 on the middleware side.

Socket/Plug Interface

Another aspect of the present invention is the definition of a socket/plug interface 146 through which the socket 136 and plug 140 components interact. The socket/plug interface 146 represents a highly generalized definition of an adapter/connector 134, regardless of which middleware tool 116 or resource (explained herein below) is being connected to the adapter/connector 134. This definition concentrates on the basic behavior of an adapter/connector 134 rather than addressing the structure of an adapter/connector 134—for the present invention comprises highly granular, loosely coupled components which are configured to meet the structural requirements of a middleware product's SDK 130.

Presented herein below is a detailed description of the socket/plug interface 146 used to communicate between the socket 136 and plug 140 components of the adapter/connector 134 of the present invention.

Reuse

The present invention maximizes reuse across developed adapters/connectors 134. The maximizing of reuse by the present invention results from dividing the adapter/connector 134 into the socket 136 and plug 140 components, discussed herein above. Some areas of reuse are apparent at initial design of the adapter/connector 134, whereas some reusable components may only be identified through implementation experience.

Reuse of the adapters/connectors 134 of the present invention takes the following forms:

Application specific reuse. The plug 140 components are specific to a certain application 108 and can be reused across adapters/connectors 134 for multiple middleware tools 130.

Middleware specific reuse. The socket 136 components are specific to a certain middleware tool 130 and can be reused across adapters/connectors 134 for multiple applications 108, 110, 112, 114.

Global reuse. At least part of the socket 136 and the plug 140 components are reusable regardless of which specific application 108 or middleware tool 130 the adapter/connector 134 is for.

Examples of the above-mentioned forms of reuse of the present invention are presented herein below. The present invention provides a framework by which the reusable behavior of the adapter/connector 134 is isolated from any middleware implementation 116, resulting in component libraries to be used across multiple adapters/connectors 134 which support the different types of reuse (application specific reuse, middleware specific reuse, and global reuse) described herein above. For example, one of the libraries corresponds to plug 140, and another of the libraries corresponds to socket 136.

Services and Resources

In the present invention, adapter/connector 134 functionality is divided into services and resources. Application-specific services and resources are isolated into the plug 140.

Services

A service is a component that performs a single task. The majority of the functionality provided by the adapter/connector 134 of the present invention is provided by tasks, also referred to as service components. The service components are highly granular to allow for the most flexibility in how they are used within an adapter/connector 134. If several services need to be executed to perform a less granular task, then a compound service is implemented which manages the execution flow between the lower level, component services.

The adapter/connector 134 of the present invention provides three types of services:

(1) Management services 143: Management services manage adapter/connector 134 state and include such tasks as initialization, startup, shutdown, polling, etc. There should only be one instance of each of these services within the adapter/connector 134. Accordingly, the execution of these services is synchronized in order to prevent any threading issues from occurring. Also, the management services use other management services.

For example, if the adapter/connector 134 is already running and the startup service is invoked, the startup service could invoke the shutdown service prior to restarting the adapter/connector 134. The management services are available for application specific reuse.

(2) Transaction services 145: Transaction services use the application API 150 to support a single transaction and are responsible for communicating data to and from the application 108. Transaction services are also available for application specific reuse.

(3) Translation services 147: Translation services are responsible for translating data between its middleware 116 form and its application 108 form. Because the translation services have explicit knowledge of both the application 108 and the middleware 116, the translation services are functionally part of the socket 136, and are shown in FIG. 5 as translation 138. The translation service wraps the transaction service, providing a seamless interface to middleware specific adapter/connector components as defined in the corresponding middleware's SDK (also referred to as socket components). By keeping the translation module separate in this manner the translation routines can be easily adapted to meet custom requirements or integrate with a third party canonical data modeling tool. Parts of these services may or may not be available for application specific and/or middleware specific reuse.

Both management services and transaction services also provide service descriptor objects to the middleware specific adapter/connector components isolated in the socket components. The service descriptor objects provide a mechanism to pass information (such as bean properties and input/output parameters) between the service isolated into the plug 140 and the middleware specific component isolated into the socket 136 and using the service.

Resources

Resources164 are components that are needed by the services to perform their tasks. Resources 164 are used in a global manner across the adapter/connector 134 of the present invention. An example of a resource is any kind of connections to the application 108 that are made by the adapter/connector 134. These may be connections to an ORB, an RMI registry, a database, etc. A connection of this type is used across multiple services, so the connection remains structurally separate and available for use.

These kinds of resources may also be available for global reuse. It is likely that core functionality for making certain types of connections could be reused for any application 108, 110, 112, 114 that uses the same type of API 150. For example, base functionality for dealing with CORBA API's may be abstracted and reused in any adapters/connectors 134 that communicate to an application 108, 110, 112, 114 via CORBA.

Another type of resource that all the services may require is what is referred to as a middleware service provider. Some functionality a service may need is inherently middleware specific. This behavior could not be implemented inside the service itself without compromising the service's reusability.

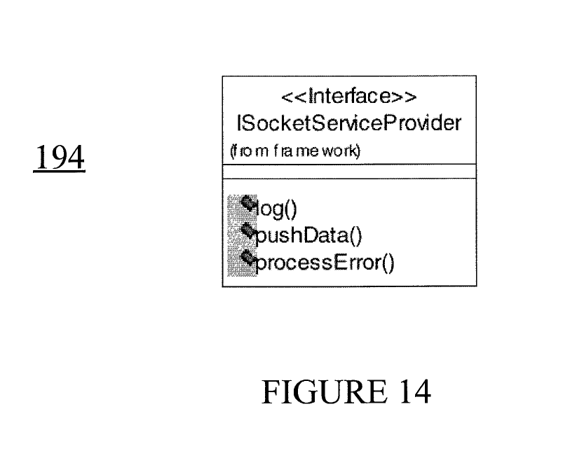

Examples of this type of functionality include logging, error handling, and initiating a data push from the application. The present invention provides an interface (the ISocketServiceProvider 194, shown in FIG. 14) that defines the functionality available through this middleware service provider resource. Then for each type of middleware tool, the present invention defines a class which implements this interface. This class is available for middleware-specific reuse. Regardless of which application 108, 110, 112, 114 the adapter/connector 134 was communicating with, its implementation does not change.

Object Interactions

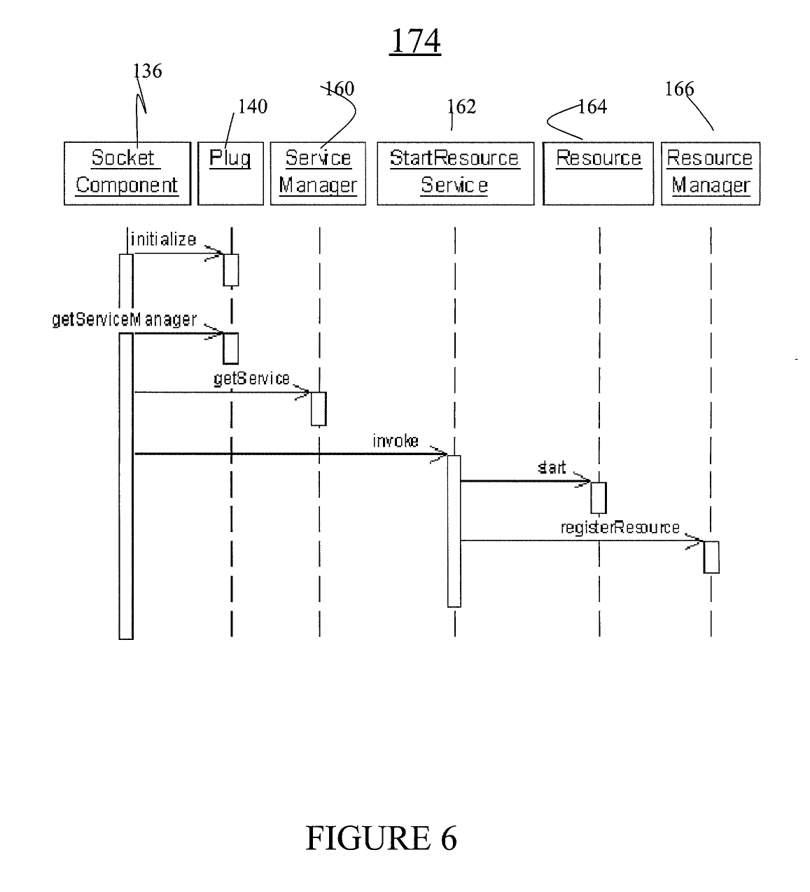

FIGS. 6-8 show are interaction diagrams which show functionally how a socket 136 initiates use of the some of the above-mentioned services and resources isolated into the plug 140. In FIGS. 6-8, objects such as the socket component 136, the plug 140, the service manager 160, the StartResourceService 162, the Resource 164, the ResourceManager 166, the StopResourceService 168, the Translator 138, the Service 172, and the Application API 150 are objects which interact with each other as described.

FIG. 6 shows Management Service—Start Resource 174. As shown in FIG. 6, the socket component 136 initializes the plug 140 and retrieves the ServiceManager instance 160 by invoking getServiceManager. The socket component 136 retrieves the StartResource service 162 by invoking getService on the ServiceManager 160. The socket component 136 invokes the StartResource service 162. The StartResource service 162 invokes start on the resource 164 and registers the resource 164 with the ResourceManager 166 by invoking registerResource.

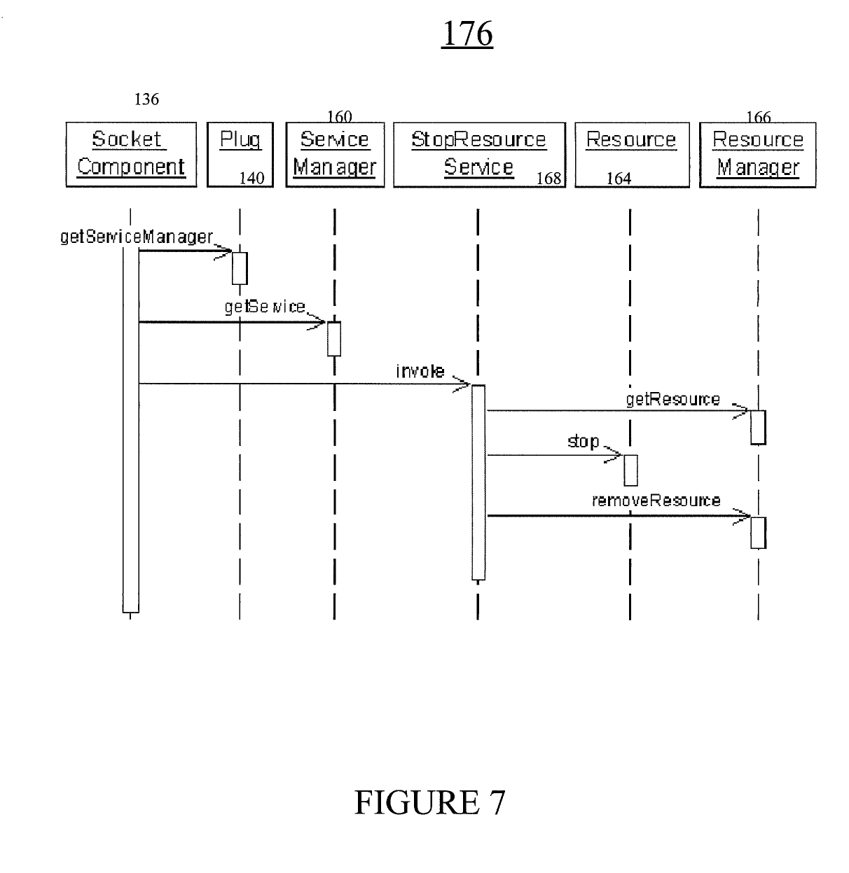

FIG. 7 shows Management Service—Stop Resource 176. As shown in FIG. 7, the socket component 136 retrieves the ServiceManager instance 160 by invoking getServiceManager. The socket component 136 retrieves the StopResource service 168 by invoking getService on the ServiceManager 160. The socket component 136 invokes the StopResource service 168. The StopResource service 168 retrieves the resource 164 from the ResourceManager 166 by invoking getResource, invokes stop on the resource 164, and removes the resource 164 from the ResourceManager 166 by invoking removeResource.

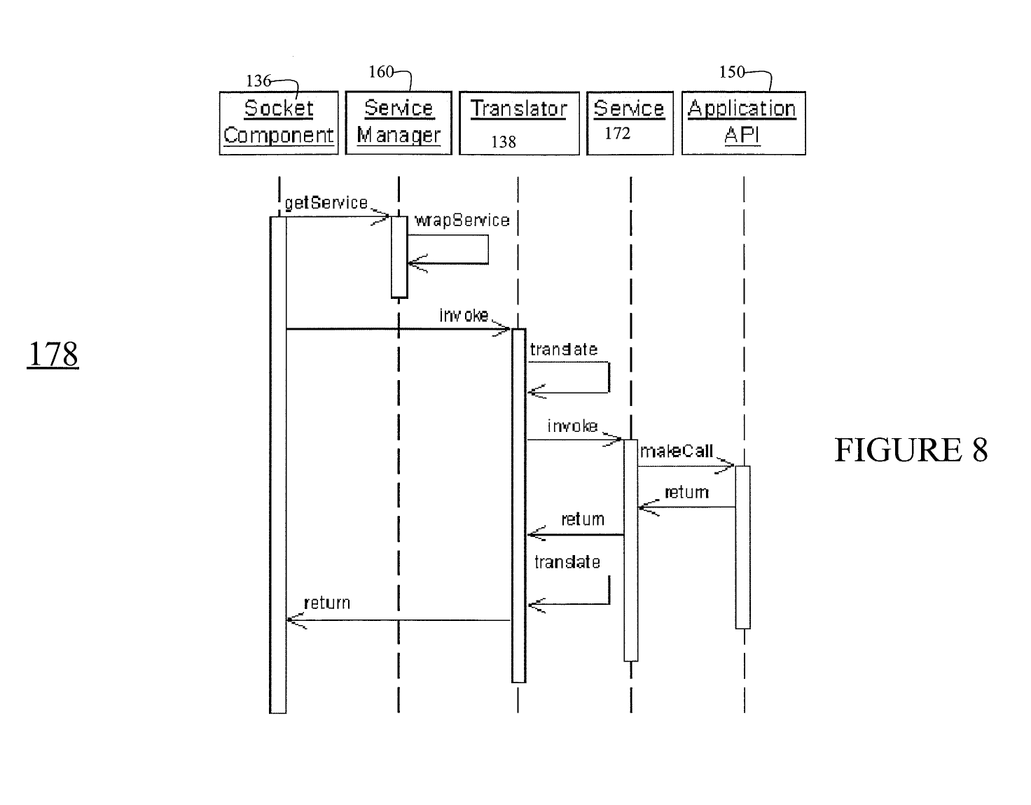

FIG. 8 shows Transaction Service 178. As shown in FIG. 8, the socket component 136 retrieves the service 172 by invoking getService on the ServiceManager 160. The ServiceManager 160 wraps the service 172 in a translator 138 and returns the wrapped service 172 to the socket component 136. The socket component 136 invokes the translator 138. The translator 138 translates the incoming data and invokes the service 172. The service 172 executes a call to the application API 150 and returns data to the translator 138. The translator 138 translates the returned data and returns the data to the socket component 136.

The Translation Service discussed herein above and shown in FIG. 5 is implemented as part of the Transaction Service shown in FIG. 5. Moreover, as shown in FIG. 8, Service 172 corresponds to the foregoing Transaction Service, and Translator 138 corresponds to the foregoing Translation Service.

Core Classes and Interfaces

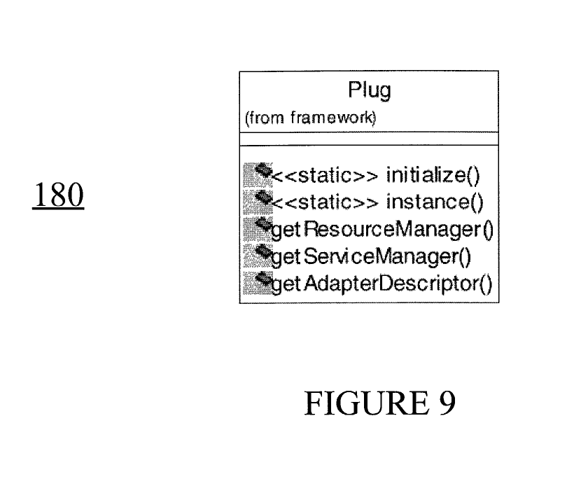

FIGS. 9-15 show core classes and interfaces, including object interactions as standard UML functions. That is, FIGS. 9-15 define the socket/plug interface 146 between the socket 136 and the plug 140. More particularly, FIGS. 9-15 comprises the socket/plug interface 146 shown in FIG. 5.

Plug

As shown in FIG. 9, plug 180 is a singleton class through which all socket code 136 accesses plug objects 140 through socket/plug interface 146 and holds reference to both the service 160 and resource manager 166.

Socket

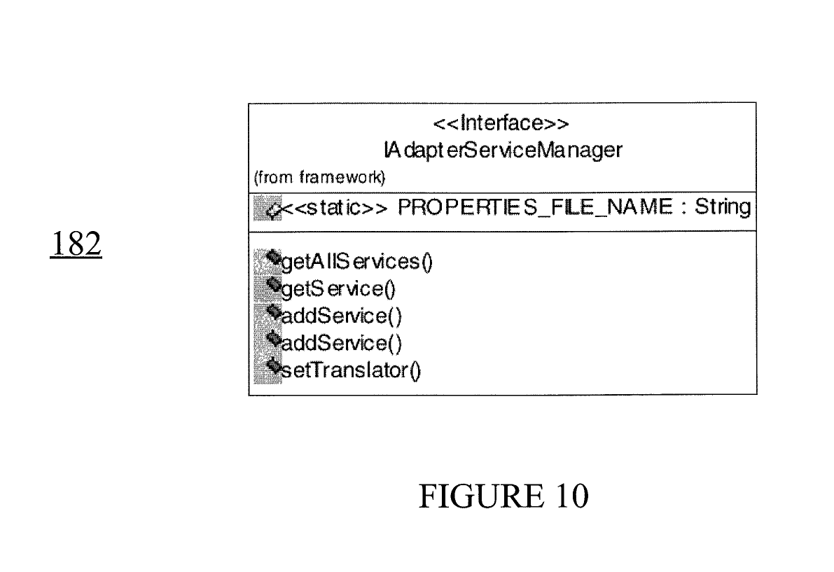

The interfaces shown in FIGS. 10-15 define how the socket 136 views, and interacts with, the plug 140 and are part of the socket/plug interface 146.

IAdapterServiceManager

As shown in FIG. 10, the IAdapterServiceManager interface 182 describes a class that controls how the services are created and controls all access to the services. Each service is retrieved from this class via a String service name. The String service name is used to ensure that management services are instantiated only once and that transaction services are wrapped in the correct translation service 138.

IAdapterService and IAdapterTranslator

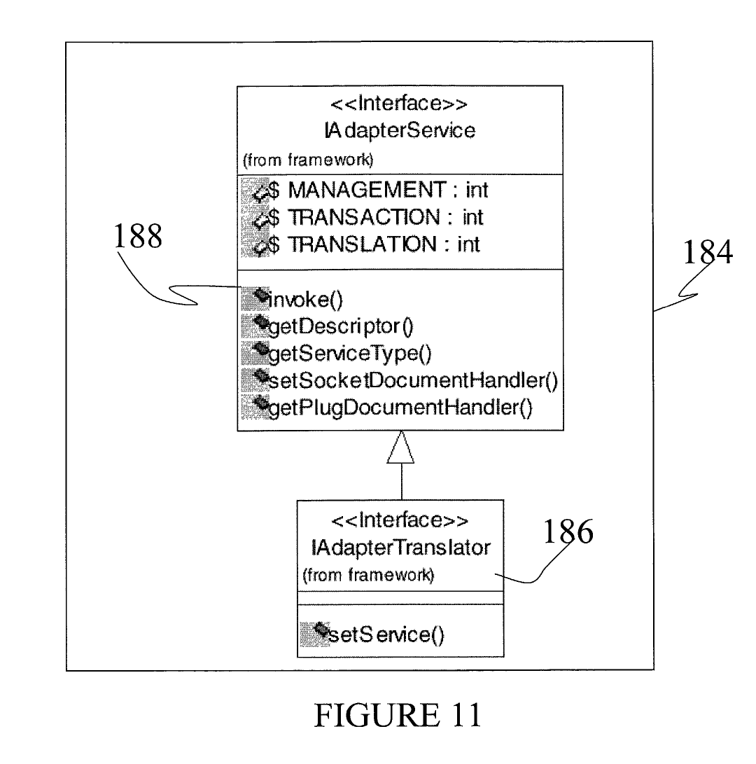

Referring to FIG. 11, the IAdapterService interface 186 and the IAdapter Translator interface 188 work in conjunction 184 with each other. That is, the IAdapterService interface 186 defines the behavior that each service must support. The IAdapterTranslator 188 interface extends the IAdapterService interface 186, adding in the behavior needed by a translation service 138.

IAdapterResourceManager

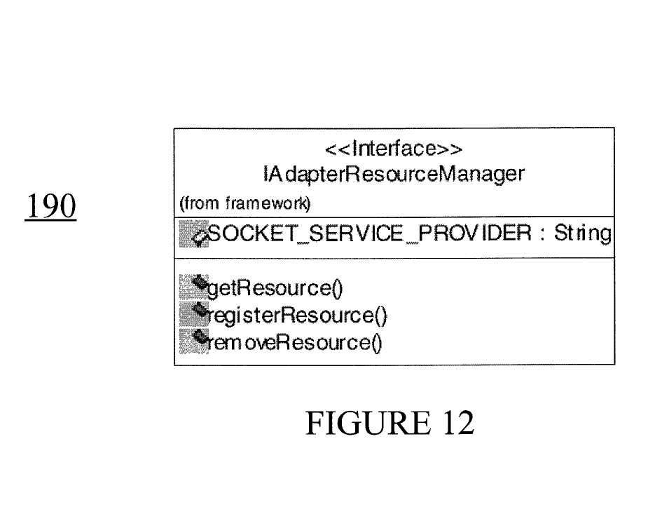

As shown in FIG. 12, the IAdapterResourceManager interface 190 describes a class that allows access to all resources. Resources are registered with this class with a String resource name and are retrieved via that name. This class is a storage mechanism and does not perform an instantiation of resources. For example, a management service used for startup would be responsible for creating the connection to the application 108, 110, 112, 114.

That startup service then registers that connection resource with this class under a resource name. Transaction services that need that connection to perform their tasks would then retrieve the resource from this class via its resource name.

IServiceDescriptor

The IServiceDescriptor interface 192 describes a service's descriptor object, as shown in FIG. 13.

ISocketServiceProvider

The ISocketServiceProvider interface 194 describes a class which provides the socket-specific functionality, as shown in FIG. 14.

ServiceParameter

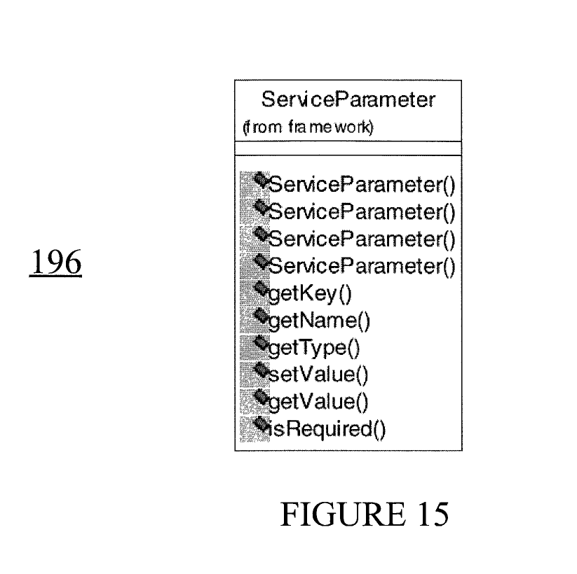

The ServiceParameter class 196 contains the attributes for a single service parameter. These attributes include parameter name, type, value, key, and whether the parameter is required., as shown in FIG. 15.

Plug XML Properties File

When initializing the Plug singleton 180 shown in FIG. 9, the name of the properties file 198 must be passed as an argument. This properties file is in XML format and contains the following information:

the implementation class for IAdapterServiceManager

the implementation class for IAdapterResourceManager

the implementation class for IServiceDescriptor

the list of services including service key, class name, and (if needed) the class name of the translator

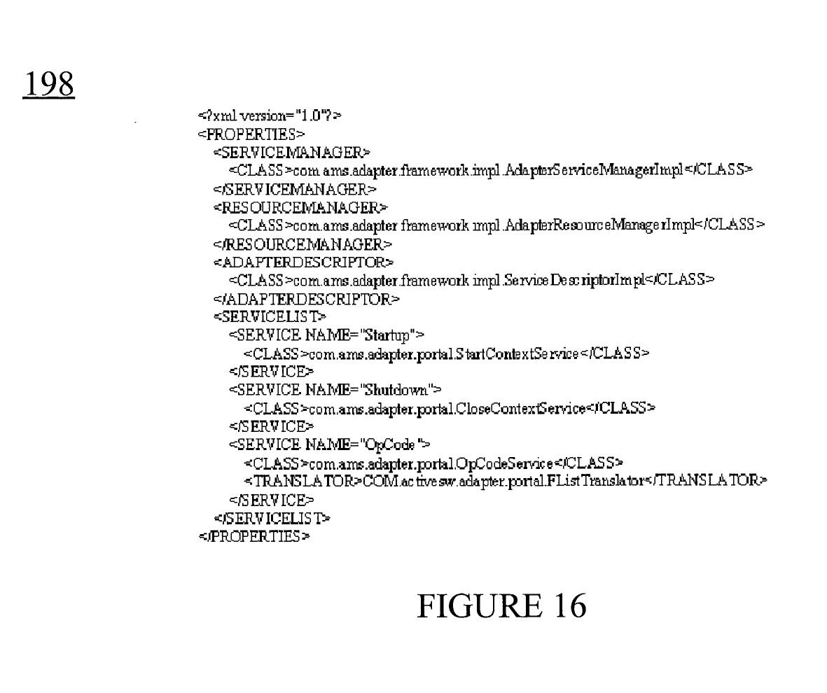

An example of a properties file 198 is shown in FIG. 16. The properties file 198 shown in FIG. 16 is an XML configuration file that is read by the adapter/connector 134 of the present invention and allows the socket 136 to be unaware of which application 108, 110, 112, 114 is performing the requested work.

Package Structure

The following is a list of file groupings of the plug 140. That is, the following is an example of the view that the socket 136 has of the plug 140 and is a template of how the socket 136 would communicate with the plug 140.

com.ams.adapter.framework

This package contains the core classes and interfaces (described herein above) used within the adapter/connector 134 of the present invention.

com.ams.adapter.framework.impl

This package contains the standard implementations of the core interfaces for the adapter/connector 134 of the present invention.

com.ams.adapter.framework.middleware_name

This package contains any reusable code for the given middleware 116. None of the code in this package makes reference to any specific application 108, 110, 112, 114.

com.ams.adapter.app_name

This package contains the code for the plug class library (where app_name would represent the name of the application 108, 110, 112, 114). None of the code in this package makes reference to any specific middleware 116.

Computer System

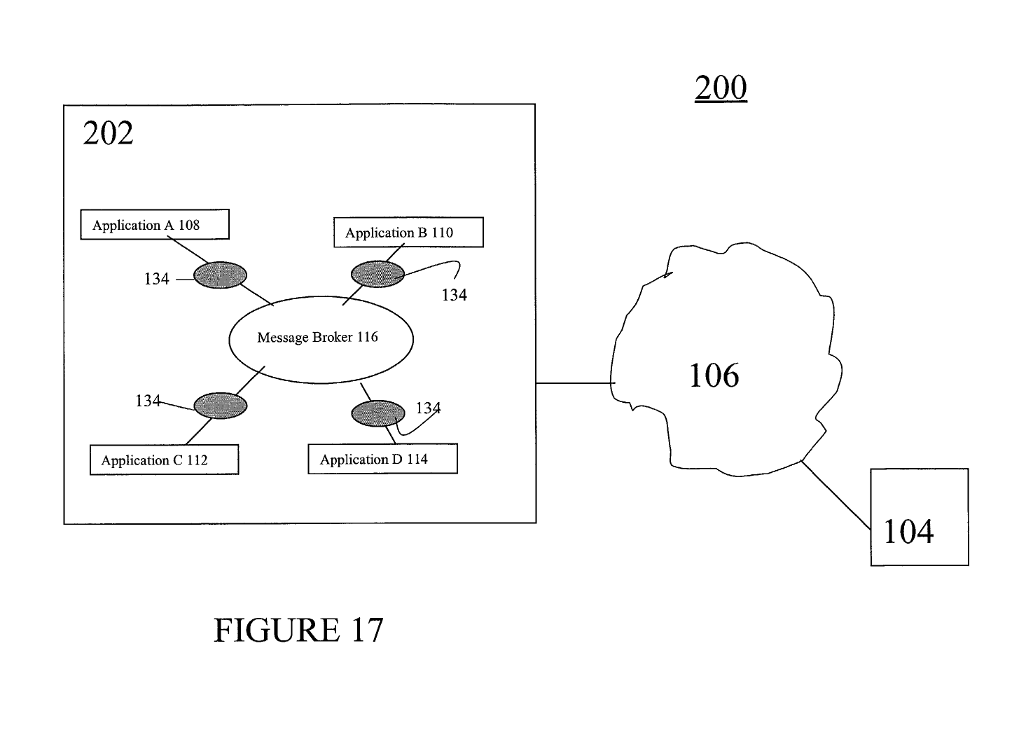

FIG. 17 shows a computer system 200 in which the adapter/connector 134 of the present invention is included. As shown in FIG. 17, the computer system 200 would include a similar device 104 and network 106 described herein above. However, the computer system 200 includes a computer 202 in which each of applications A 108, B 110, C 112, and D 114 interfaces to message broker (or middleware 116) through a respective adapter/connector 134 of the present invention.

Moreover, the adapter/connector 134 includes a computer-readable medium such as a disk storing a program which when executed by a computer 202 causes the computer 202 to isolate application-specific services and resources into plugs 136 of an adapter/connector 134 and middleware-specific components into the sockets 140 of the adapter/connector 134.

Development and Testing

Moreover, the present invention streamlines adapter/connector testing by allowing a more granular, component-based testing approach, and allows a division of development labor, making the most of varied subject matter experts.

An example of a process for developing and testing adapters/connectors 134 of the present invention is presented. The present invention allows for a division of development effort, allowing application and middleware experts to concentrate on independent plug 140 and socket 136 development, respectively.

Development Steps

As adapters/connectors 134 of the present invention are constructed for new middleware products 116, part of the initial analysis of constructing the adapter/connectors 134 determines whether it is possible to build a reusable socket 136 for the corresponding SDK 130. If so, future adapters/connectors 134 for the middleware product 116 would be developed very rapidly, especially if the needed plug 140 is also pre-existing.

Whether or not it is desirable to develop a reusable socket or a plug-specific socket depends upon the SDK 130. For example, an SDK 130 which makes extensive use of reflection (Java language introspection) would likely make developing a reusable socket 136 less desirable, and development of a socket 136 that is plug-specific more desirable.

Typically, the application plug 140 is developed and tested completely independent of any middleware tools 116.

Also, since the plug's 140 services (that is, communication 142 and connection 144, described herein above) are loosely coupled, new services can be added or existing services can be changed readily. Once a plug 140 is developed for a specific application 108, the plug 140 represents a reusable library of components that greatly reduce the effort of creating adapters/connectors 134 for that application 108.

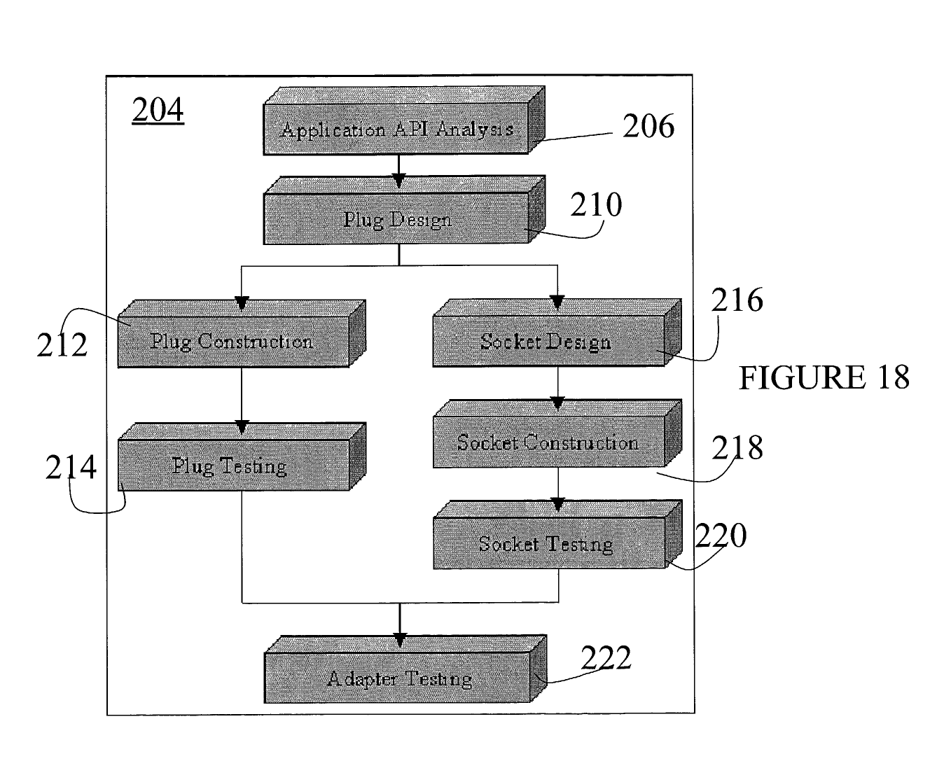

FIG. 18 illustrates a flow 204 for developing an adapter/connector 134 of the present invention. Initially, a thorough analysis of the application's API 150 is performed 206. Once the application's API 150 is understood then the design 208 of the application plug 140 can take place. The major deliverable from this process is a complete definition of the plug's140 services—including their inputs, outputs, and required parameters. Until these services are defined, construction of the plug 140 cannot begin and no design can be done on the socket 136.

With the services defined, the development effort for the plug 140 and the socket 136 can be executed in parallel. Part of the development team can begin construction 212 of the plug 140 and, once complete, can continue into stand-alone testing 214.

Another part of the team takes the service definitions and begins designing 216 the socket 136 (also referred to as the connecting socket). This design stage includes determining how the plug's 140 services map to the middleware SDK 130 and defining the translation 138 algorithms. With those factors determined, the socket 136 can then be constructed 218 and limited stand-alone testing 220 can be accomplished. Extensive code generation is used to create the socket 136.

With both plug 140 and socket 136 developed and tested separately, the final process is full point-to-point adapter/connector 134 testing 222. The final process 222 verifies that the communication between socket 136 and plug 140 is correct—with a major emphasis on validating the translation 138 routines of the socket.

As more and more adapters/connectors 134 are developed many steps in the development process 204 can be eliminated. For example, if an existing plug 140 is available for an application 108, developing a different adapter/connector 134 for that application 108 would not require the plug design, construction, and testing steps.

As the number of adapters/connectors 134 developed increases, the availability of reusable components significantly decreases the development effort.

Testing

One of the most complex and time consuming tasks in adapter/connector 118 development is testing. Typical adapter/connector 118 testing can usually only be performed via a complete end-to-end functionality test which requires a tester to have expertise in both the application 108 and the middleware tool 116. If issues arise during this kind of testing, it is often difficult to pinpoint the cause of the problem. An issue could be a result of an error in the setup of the middleware tool 116, a bug in the translation 138 algorithm, a bad connection to the application 108, or a problem in the application API itself.

The adapter/connector 134 of the present invention allows for component-based testing. A simple test suite for the application plug 140 provides a basic runtime structure used for verifying that each service provided by the application plug 140 works as intended. That is, the plug 140 can be tested completely independent of any middleware 116, which allows for a more focused testing of the connection and communication with the application 108. The translation module(s) 138 are tested independently as well. Therefore, by the time that the adapter/connector 134 is tested for end-to-end functionality, there is a high level of confidence in these components. This results in fewer testing issues and in issues which are easier to resolve.

In addition, a simple test suite verifies socket 136 functionality, allowing for some testing of the socket 136 without the application plug 140. However, most of the testing for the socket 136 needs to be in combination with the plug's 140 functionality.

Deliverables

Each of the design steps within the development process produces a specification document. These specifications flow into the following design and/or construction processes. For example, the plug 140 design specification is used extensively in the design of the socket 136.

The plug 140 specification should include the following:

a list of all adapter/connector resources along with a description of each,

a list of all services along with a description for each, which resources each service uses, the inputs and outputs for each service (including types), and the parameters needed by each service (including types),

a description of any special design strategies employed in the plug 140. For example, if the plug 140 is using JNI software to wrap a C API, the details of the approach used to accomplish this are described in detail.

The socket design specification details the middleware-specific aspects of the adapter/connector 134. The form of this design specification is dictated by the requirements of the middeware tool 116 and could include items such as adapter/connector initialization parameters, interaction with the middleware's GUI tool set (if any), etc. The socket design specification also details how the socket uses the plug services within the middleware SDK as well as address the approach used to handle data translation.

Term/Acronym Definition

API—Application Programming Interface.

CORBA—Common Object Request Broker Architecture. This is a distributed object model developed and maintained by the Object Management Group (OMG). It allows programs to communicate through remote Object Request Brokers (ORBs).

COTS—Commercial Off-The-Shelf. Pre-packaged applications which are not customer-specific.

DCOM—Distributed Component Object Model. This is Microsoft's distributed object protocol.

EAI—Enterprise Application Integration.

EJB—Enterprise Java Beans. This is a Java specific distributed object technology based on the JavaBeans specification.

JNI—Java Native Interface. This is a toolset used to allow Java to communicate with native languages such as C/C++.

Message Broker—An integration mediator that directs the flow of information between applications.

ORB—Object Request Broker. Software that allows distributed objects to communicate with each other across differing languages, machines, operating systems, and networks.

RMI—Remote Method Invocation. A Java-based distributed technology which allows Java objects to execute methods on other objects across a network.

SAX—Simple API to XML. This is an industry-defined event-driven parser API for XML data.

SDK—Software Development Kit.

SOAP—Simple Object Access Protocol. This is a lightweight proto-col, based on XML, for exchange of information in a decentralized, distributed environment

XML—Extensible Markup Language. This is a platform and language independent form of structuring data.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of interfacing between middleware software and application software using a plug and socket approach, comprising:
isolating application-specific services and resources into a plug and middleware-specific components into a socket.

2. The method as in claim 1, further comprising:
transmitting data between the plug and a socket through an interface.

3. The method as in claim 2, further comprising:
communicating with the application through an application API; and
communicating with the middleware through a middleware API.

4. The method as in claim 2, wherein the socket translates data between a format prescribed by the middleware software and a format prescribed by the application.

5. The method as in claim 4, wherein the socket is knowledgeable about the plug through the interface to the plug.

6. The method as in claim 5, wherein the socket communicates with the application through the plug without being knowledgeable about the interface to the plug.

7. The method as in claim 1, wherein the plug is customized to the application software.

8. The method as in claim 1, wherein the plug is reusable across middleware platforms.

9. The method as in claim 1, wherein the socket is usable across plugs.

10. An apparatus comprising:
an adapter/connector interfacing between middleware software and application software using a plug and socket approach, said adapter/connector comprising:
a plug isolating application-specific services and resources, and
a socket in communication with the plug and isolating middleware-specific components.

11. The apparatus as in claim 10, further comprising:
an interface transmitting data between the plug and the socket.

12. The apparatus as in claim 11, wherein the socket translates data between a format prescribed by the middleware software and a format prescribed by the application software.

13. The apparatus as in claim 12, wherein the adapter/connector transmits the data to the application software through an application API, and to the middleware software through a middleware API.

14. The apparatus as in claim 11, wherein the socket is knowledgeable about the plug through the interface to the plug.

15. The apparatus as in claim 14, wherein the socket communicates with the application through the plug without being knowledgeable about the interface to the plug.

16. The apparatus as in claim 10, wherein the plug is customized to the application software.

17. The apparatus as in claim 10, wherein the plug is reusable across middleware platforms.

18. The apparatus as in claim 10, wherein the socket is usable across plugs.

19. The method as in claim 1, wherein the plug and the socket are developed and tested substantially independently of each other.

20. The apparatus as in claim 10, wherein the plug and the socket are developed and tested substantially independently of each other.

21. A computer-readable medium storing a program which, when executed by a computer, causes the computer to execute processes comprising:
interfacing between middleware software and application software using a plug and socket approach, comprising isolating application-specific services and resources into a plug and middleware-specific components into a socket.

22. The computer-readable medium as in claim 21, further comprising:
transmitting data between the plug and a socket through an interface.

23. The computer-readable medium as in claim 22, further comprising:
communicating with the application through an application API; and
communicating with the middleware through a middleware API.

24. The computer-readable medium as in claim 22, wherein the socket translates data between a format prescribed by the middleware software and a format prescribed by the application.

25. The computer-readable medium as in claim 24, wherein the socket is knowledgeable about the plug through the interface to the plug.

26. The computer-readable medium as in claim 25, wherein the socket communicates with the application through the plug without being knowledgeable about the interface to the plug.

27. The computer-readable medium as in claim 21, wherein the plug is customized to the application software.

28. The computer-readable medium as in claim 21, wherein the plug is reusable across middleware platforms.

29. The computer-readable medium as in claim 21, wherein the socket is usable across plugs.

30. The computer-readable medium as in claim 21, wherein the plug and the socket are developed and tested substantially independently of each other.
